(19) United States
(12) Patent Application Publication
(10) Pub. No.: US 2023/0036140 A1
(43) Pub. Date: Feb. 2, 2023

(54) WIRELESS AWARE NETWORK STACK

(71) Applicant: Microchip Technology Incorporated, Chandler, AZ (US)

(72) Inventor: Vaibhav Madan, Uttar Pradesh (IN)

(21) Appl. No.: 17/815,281

(22) Filed: Jul. 27, 2022

(30) Foreign Application Priority Data
Jul. 27, 2021 (IN) 202141033677

(51) Int. Cl. H04L 1/08; H04W 28/04

(52) U.S. Cl. CPC H04L 1/08; H04W 28/04

(57) ABSTRACT

A feedback mechanism about a state of a transmission of a packet over a wireless medium is disclosed. In one or more examples, a wireless stack determines a state of a transmission of wireless packets that correspond to the network packet and infers a state of transmission of the network packet based on such a determination. The wireless stack informs a network stack about the state of transmission of the network packet.

### PRIORITY CLAIM

Pursuant to 35 U.S.C. § 119(a), this application claims the benefit of the filing date of Indian Provisional Patent Application Serial No. 202141033677, filed Jul. 27, 2021, for “Wireless Aware Network Stack,” the disclosure of which is hereby incorporated herein in its entirety by this reference.

### TECHNICAL FIELD

This disclosure relates generally to a feedback mechanism about a state of a transmission of a packet over a wireless medium is disclosed. In one or more examples, a wireless stack determines a state of a transmission of wireless packets that correspond to the network packet and infers a state of a transmission of the network packet based on such a determination. The wireless stack informs a network stack about the state of the transmission of the network packet.

### BACKGROUND

Systems, devices, and applications utilize a variety of communication protocols to communicate (i.e., perform electronic communication). Sometimes they communicate over a wireless network, a wired network, and combinations thereof.

### BRIEF DESCRIPTION OF THE DRAWINGS

To easily identify the discussion of any particular element or act, the most significant digit or digits in a reference number refer to the figure number in which that element is first introduced.

FIG. 1 is a diagram depicting a communication that includes immediate feedback about a state of a transmission of a packet over a wireless medium, in accordance with one or more examples.

FIG. 2 is a flow diagram depicting a process in accordance with one or more examples.

FIG. 3 is a block diagram depicting a system in accordance with one or more examples.

### DETAILED DESCRIPTION

In the following detailed description, reference is made to the accompanying drawings, which form a part hereof, and in which are shown, by way of illustration, specific examples of examples in which the present disclosure may be practiced. These examples are described in sufficient detail to enable a person of ordinary skill in the art to practice the present disclosure. However, other examples enabled herein may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. In some instances, similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example nor this disclosure to the specified components, steps, features, functions, or the like.

It will be readily understood that the components of the examples as generally described herein and illustrated in the drawings could be arranged and designed in a wide variety of different configurations. Thus, the following description of various examples is not intended to limit the scope of the present disclosure, but is merely representative of various examples. While the various aspects of the examples may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are examples only and should not be construed as the only way to implement the present disclosure unless specified otherwise herein. Additionally, block definitions and partitioning of logic between various blocks are examples of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art will understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, units, logic and circuits described in connection with the examples disclosed herein may be implemented or performed with a general purpose processor, a special purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein—all of which are encompassed by use of the term “processor.” A general-purpose processor may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code, without limitation) related to examples of the present disclosure.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term “substantially” in reference to a given parameter, property, or condition means and includes to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least 90% met, at least 95% met, or even at least 99% met.

As used herein, any relational term, such as “over,” “under,” “on,” “underlying,” “upper,” “lower,” without limitation, is used for clarity and convenience in understanding the disclosure and accompanying drawings and does not connote or depend on any specific preference, orientation, or order, except where the context clearly indicates otherwise.

In this description the term “coupled” and derivatives thereof may be used to indicate that two elements co-operate or interact with each other. When an element is described as being “coupled” to another element, then the elements may be in direct physical or electrical contact or there may be intervening elements or layers present. In contrast, when an element is described as being “directly coupled” to another element, then there are no intervening elements or layers present. The term “connected” may be used in this description interchangeably with the term “coupled,” and has the same meaning unless expressly indicated otherwise or the context would indicate otherwise to a person having ordinary skill in the art.

As used herein, “network stack” means an implementation of a network communication protocol. As used herein, “wireless stack” means an implementation of a wireless communication protocol. In one or more examples, respective implementations of a network stack or wireless stack may be a software implementation, a hardware implementation, or a combinations thereof. Wireless communication protocols of one or more examples include, but are not limited to, WiFi (the Institute of Electrical and Electronics Engineers (IEEE) 802.11 standards for implementing WLAN computer communication, also referred to as “WiFi”), Bluetooth, Bluetooth low energy (BLE), and Near Field Communication (NFC). Network communication protocols of various examples include, but are not limited to, Transmission Control Protocol (TCP), Internet Protocol (IP), and User Datagram Protocol (UDP).

A network stack may communicate, knowingly or unknowingly, over a wireless network via one or more wireless stacks. Wireless networks are typically lossy (i.e., experience some loss of data), and network packets transmitted over a wireless network may be lost (i.e., fail to arrive at one or more intended destinations), as non-limiting examples, by unintentionally (e.g., due to noise or lost connections, without limitation) or because it is dropped (i.e., a wireless router deliberately does not pass a packet on to its next hop, e.g., because the router is overloaded, determines that the packet is malicious or should be otherwise filtered, or the router has been compromised and is dropping otherwise legitimate network packets).

A transmitting network stack is not specifically aware of a state of a transmission of a network packet (e.g., independently monitoring the state of a transmission of a network packet, without limitation) over a wireless network nor that a network packet or that a network packet has been lost, and relies, for example, on feedback from a receiving network stack before it (the transmitting network stack) takes corrective action, if any.

The inventor of this disclosure appreciates that there is a time cost associated with a receiving network stack to generate and send feedback (as well as sometimes time associated with requesting feedback from a receiving network stack) before determining that a transmission of a network packet failed. Time cost of such a feedback mechanism contributes to delay of a communication. Further, some communication protocols, such as UDP, without limitation, do not provide feedback that may be utilized to infer that a network packet was dropped. Accordingly, parties may experience incomplete communications (e.g., from data loss, without limitation) or fail to establish a connection for communication. Such inferring may also be characterized as “detecting” that a network packet has or will be lost.

A network stack of a transmitter being in communication with a wireless stack of a transmitter, where the communication link between network stack and wireless stack can carry information about the state of transmission of one or more wireless packets or network packets may be referred to herein as being “wireless aware,” e.g., such a network stack is “wireless aware,” without limitation. By way of non-limiting example, a wireless aware network stack may use information about the state of transmission of wireless packets or network packets to learn, determine or infer a state of transmission of network packets, as discussed below.

One or more examples relate, generally, to local feedback about a state of a transmission of a network packet, and more specifically, a local feedback mechanism for a wireless stack of a transmitting device (also referred to herein as a “Tx wireless stack”) to inform a network stack of the transmitting device (also referred to herein as a “Tx network stack”) about a state of a transmission of a network packet. In one or more examples, the state may correspond to a failed transmission of a network packet, i.e., a lost network packet.

In one or more examples, a Tx wireless stack may infer that transmission of a network packet failed at least partially responsive to determining that a transmission of one or more wireless packets (also referred to as “wireless packets”) that correspond to the network packet failed. As a non-limiting example, in a use case that operates according to the Open Systems Interconnection (OSI) model communication in or by a computing system, such wireless packets are protocol packets exchanged at layer 2 and layer 1 of the OSI stack and such network packets are protocol packets exchanged at layer 3 and layer 4 of the OSI stack.

In one or more examples, a Tx wireless stack may determine the state of the transmission of wireless packets at least partially responsive to an indication about the state of the transmission. In one or more examples, the indication may include observing receipt, or non-receipt, of a message sent by a wireless stack of hardware (e.g., a wireless router, without limitation) managing the wireless network (such wireless stack of the hardware also referred to herein as an “HW wireless stack”). In one or more examples, receipt of such a message indicates that transmission of wireless packets was successful, and non-receipt of such a message indicates that transmission of the wireless packets was unsuccessful.

In one or more examples, upon inferring that a network packet has or will be lost, the Tx wireless stack informs the Tx network stack that the network packet was lost. In response to being informed by the Tx wireless stack that a network packed was lost, the Tx network stack may take a corrective action, such as retransmitting the network packet or restarting a connection attempt, without limitation.

A person having ordinary skill in the art will recognize many advantages and benefits afforded by disclosed examples, including, but not limited to:
increased throughput realized at least in part by immediate transmission of another network packet by the network stack in response to learning that a network packet was dropped (e.g., retransmitting the dropped network packet, without limitation),
reduced latency realized at least in part by eliminating at least some of the time that a transmitter might otherwise wait for feedback from a network stack of a receiver before transmitting another network packet (e.g., retransmitting the dropped network packet, without limitation), or
improved performance for systems utilizing network stacks for communication protocols that do not typically provide a feedback mechanism about a state of a transmission of a network packet, realized at least in part via a local feedback mechanism between a wireless stack and a network stack about a state of a transmission of a network packet that enables the network stack to detect a dropped network packet and transmit another network packet (e.g., retransmit a dropped network packet, without limitation).

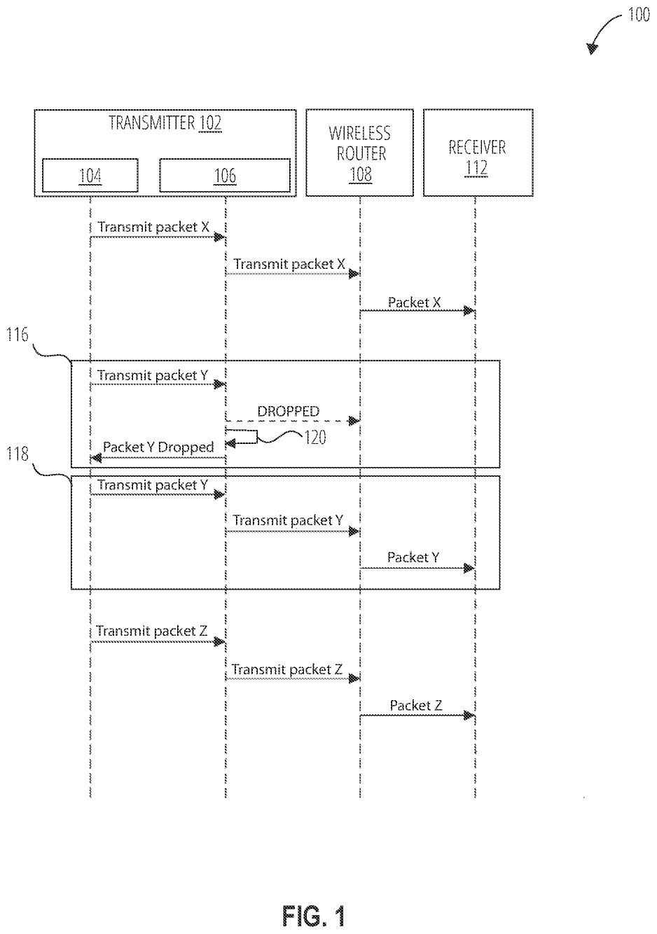

FIG. 1 is a swimlane diagram of a communication process 100 that includes feedback about a state of a transmission of a network packet, in accordance with one or more examples. In one or more examples, transmitter 102 and receiver 112 may collectively or individually be, as non-limiting examples, wireless devices, servers or cloud services. In one or more examples, transmitter 102 and receiver 112 may be, or be provided at, a wireless network managed by wireless router 108. In one or more examples, receiver 112 may be in or provided at wireless router 108 (e.g., in the same device or part of the router, without limitation).

In the specific example depicted by FIG. 1, three packets are transmitted from transmitter 102 to receiver 112 via a wireless network managed by wireless router 108: packet x, packet y, and packet z.

Tx wireless stack 106 of transmitter 102 transmits wireless packets of a network packet transmitted by Tx network stack 104 of transmitter 102, learns a state of a transmission of the wireless packets, infers a state of a transmission of the network packet, and informs Tx network stack 104 about the state of the transmission of the network packet (e.g., that a network packet was dropped, without limitation).

During first transmission 116 of network packet y, at operation 120, Tx wireless stack 106 infers that network packet y has or will be lost, and informs Tx network stack 104 of transmitter 102 that network packet y was lost. In response to being informed that network packet y was lost, Tx network stack 104 takes corrective action, and more specifically, retransmits network packet y in second transmission 118. During second transmission 118 of network packet y (i.e., the retransmission of network packet y), Tx wireless stack 106 does not infer that packet y was dropped and so does not inform Tx network stack that packet y was lost.

In one or more examples, Tx wireless stack 106 may be configured to inform Tx network stack 104 about a state of transmission of a network packet by providing an indication of the state of transmission of the network packet. In one or more examples, Tx wireless stack 106 may be configured to inform Tx network stack 104 about a state of a transmission of network packet y by invoking one or more functions of Tx network stack 104 via an application programming interface (API), where the invoked function indicates to logic of Tx wireless stack 106 that the network packet dropped.

In one or more examples, a Tx wireless stack (e.g., a Tx wireless stack 106, without limitation) infers that a network packet has been or will drop. In some specific executions, a state of a transmission of a network packet may, in actuality, be different than the state inferred by Tx wireless stack 106, without exceeding the scope of this disclosure. By way of non-limiting example, an inference may be made that a network packet has or will be dropped but the network packet is, in actuality, not dropped (e.g., received at wireless router 108, without limitation).

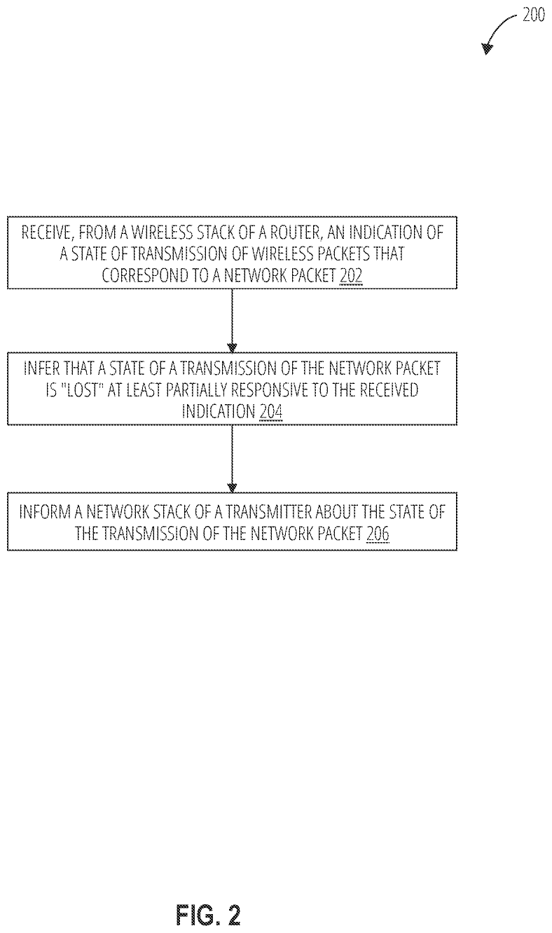

FIG. 2 is a flow diagram depicting a process 200 for providing feedback about a state of a transmission of a network packet to a network stack of a transmitting device, in accordance with one or more examples.

At operation 202, process 200 receives, from a wireless stack of a router, an indication of a state of a transmission of wireless packets that correspond to a network packet.

At operation 204, process 200 infers that a state of a transmission of the network packet is “lost” at least partially responsive to the received indication. In one or more examples, a wireless stack of the transmitter infers that the packet is lost at least partially based on a determination of whether or not the wireless stack of the transmitter received an acknowledgment message from the hardware running a wireless medium (e.g., a wireless router running a wireless network, without limitation). If the wireless stack of the transmitter determines that it did not receive an acknowledgement message, then it may infer that the state of the transmission of the network packet is “lost.” If the wireless stack of the transmitter determines that it did receive an acknowledgement message, then it may infer that the state of the transmission of the network packet is transmitted or “not lost.”

At operation 206, process 200 informs a network stack of a transmitter about the state of the transmission of the network packet. The wireless stack of the transmitter that determined whether or not an acknowledgment message was received may inform the network stack of the transmitter, via a feedback mechanism, that the network packet is lost, not lost, or transmitted. The feedback mechanism may be, as a non-limiting example, a hardware or software interrupt, flag, status register or control register and it may be located at the transmitter wireless stack and accessible to the transmitter network stack via an application programming interface (API), at a memory or circuit of the transmitter and accessible by the transmitter wireless stack and the transmitter network stack, or at the transmitter network stack and accessible to the transmitter wireless stack via an API.

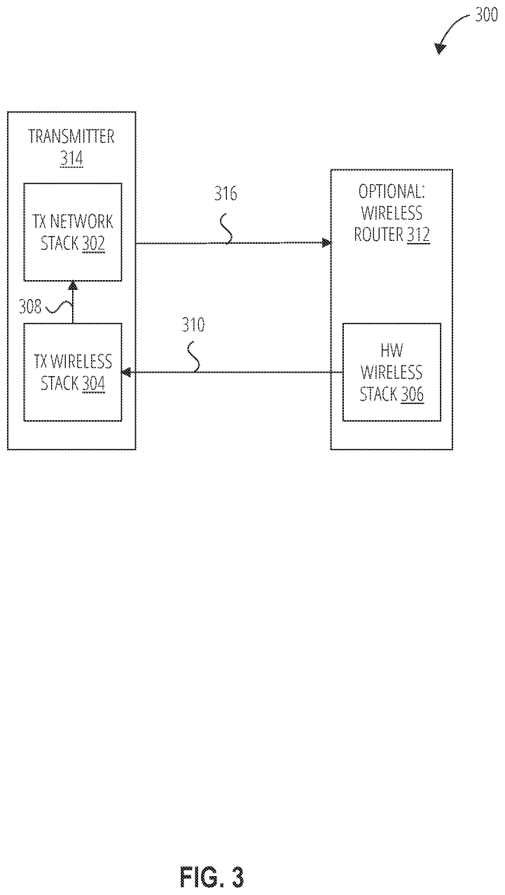

FIG. 3 is a block diagram depicting a system 300 in accordance with one or more examples. Transmitter 314 sends network packets 316 to optional wireless router 312. Transmitter 314 includes Tx wireless stack 304 and Tx network stack 302. Tx wireless stack provides local feedback 308 to Tx network stack 302 about a state of transmission of network packets 316 at least partially based on an indication 310 generated by HW wireless stack 306 (e.g., wireless stack 306 of wireless router 312, without limitation). As discussed, above, non-limiting examples of feedback mechanisms of feedback 307 include a hardware or software interrupt, flag, status register or control register and it may be located at the transmitter wireless stack and accessible by the transmitter network stack via an API at the transmitter wireless stack, a circuit of the transmitter and accessible by the transmitter wireless stack and the transmitter network stack, or at the transmitter network stack and accessible to the transmitter wireless stack via an API at the transmitter network stack.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims, without limitation) are generally intended as “open” terms (e.g., the term “including” should be interpreted as “including, but not limited to,” the term “having” should be interpreted as “having at least,” the term “includes” should be interpreted as “includes, but is not limited to,” without limitation). As used herein, the term “each” means some or a totality. As used herein, the term “each and every” means a totality.

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more,” without limitation); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations, without limitation). Furthermore, in those instances where a convention analogous to “at least one of A, B, and C, without limitation” or “one or more of A, B, and C, without limitation” is used, in general such a construction is intended to include A alone, B alone, C alone, A and B together, A and C together, B and C together, or A, B, and C together, without limitation.

Additional non-limiting examples of the disclosure include:

Example 1: An apparatus, comprising: a network stack of a wireless transmitter; and a wireless stack of the wireless transmitter, the wireless stack in communication with the network stack to inform the network stack about a state of a transmission of a network packet over a wireless medium.

Example 2: The apparatus according to Example 1, wherein an informed state of the transmission of the network packet is that the network packet was lost.

Example 3: The apparatus according to any of Examples 1 and 2, wherein the network stack takes corrective action at least partially responsive to being informed about the state of the transmission of the network packet if the network packet was lost.

Example 4: The apparatus according to any of Examples 1 through 3, wherein a taken corrective action comprises transmitting another network packet.

Example 5: The apparatus according to any of Examples 1 through 4, wherein the state of the transmission of the network packet is that the network packet was successfully transmitted over the wireless medium.

Example 6: The apparatus according to any of Examples 1 through 5, wherein the wireless stack configured to detect that the network packet dropped at least partially responsive to an indication of a state of a transmission of a wireless packet that corresponds to the network packet.

Example 7: The apparatus according to any of Examples 1 through 6, wherein the indication of the state of the transmission of the wireless packet is observing a receipt or lack of receipt of a message from a wireless stack of a receiver acknowledging the wireless packet.

Example 8: The apparatus according to any of Examples 1 through 7, wherein the indication of the state of the transmission of the wireless packet is generated at least partially responsive to lack of receipt of a message acknowledging receipt of the network packet.

Example 9: The apparatus according to any of Examples 1 through 8, wherein the wireless stack is in communication with the network stack via a message about the state of the transmission of the network packet.

Example 10: The apparatus according to any of Examples 1 through 9, wherein the wireless stack is in communication with the network stack via a function provided at the network stack and invokable to indicate the state of the transmission of the network packet.

Example 11: A method comprising: infer a state of transmission of a network packet at least partially responsive to a received indication of state of transmission of wireless packets that correspond to the network packet; and inform a network stack of a transmitter about the state of transmission of the network packet.

Example 12: The method according to Example 11, wherein inferring the state of transmission of network packet at least partially responsive to the received indication of state of transmission of wireless packets comprises: inferring the state of transmission of network packet at least partially responsive to a determination of received acknowledgment from wireless stack of wireless router.

Example 13: The method according to any of Examples 11 and 12, comprising: retransmitting network packets at least partially responsive to being informed the state of transmission of the network packet comprises dropped or lost network packets.

Example 14: A system comprising: a wireless router; and a transmitter comprising a network stack and a wireless stack in communication to control transmission of network packets at least partially responsive to locally generated feedback about a state of transmission of network packets via the wireless router.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. An apparatus, comprising:
a network stack of a wireless transmitter; and
a wireless stack of the wireless transmitter, the wireless stack in communication with the network stack to inform the network stack about a state of transmission of a network packet over a wireless medium.

2. The apparatus of claim 1, wherein an informed state of transmission of the network packet is that the network packet was lost.

3. The apparatus of claim 2, wherein the network stack takes corrective action at least partially responsive to being informed about the state of transmission of the network packet is the network packet was lost.

4. The apparatus of claim 3, wherein a taken corrective action comprises transmitting another network packet.

5. The apparatus of claim 1, wherein the state of transmission of the network packet is that the network packet was successfully transmitted over the wireless medium.

6. The apparatus of claim 1, wherein the wireless stack configured to detect that the network packet dropped at least partially responsive to an indication of a state of a transmission of a wireless packet that corresponds to the network packet.

7. The apparatus of claim 6, wherein the indication of the state of transmission of the wireless packet is observing a receipt or lack of receipt of a message from a wireless stack of a receiver acknowledging the wireless packet.

8. The apparatus of claim 6, wherein the indication of the state of transmission of the wireless packet is generated at least partially responsive to lack of receipt of a message acknowledging receipt of the network packet.

9. The apparatus of claim 1, wherein the wireless stack is in communication with the network stack via a message about the state of transmission of the network packet.

10. The apparatus of claim 1, wherein the wireless stack is in communication with the network stack via a function provided at the network stack and invokable to indicate the state of transmission of the network packet.

11. A method comprising:
infer a state of transmission of a network packet at least partially responsive to a received indication of state of transmission of wireless packets that correspond to the network packet; and
inform a network stack of a transmitter about the state of transmission of the network packet.

12. The method of claim 11, wherein inferring the state of transmission of network packet at least partially responsive to the received indication of state of transmission of wireless packets comprises:
inferring the state of transmission of network packet at least partially responsive to a determination of received acknowledgment from wireless stack of wireless router.

13. The method of claim 11, comprising: retransmitting network packets at least partially responsive to being informed the state of transmission of the network packet comprises dropped or lost network packets.

14. A system comprising:
a wireless router; and
a transmitter comprising a network stack and a wireless stack in communication to control transmission of network packets at least partially responsive to locally generated feedback about a state of transmission of network packets via the wireless router.
